(19) United States
(12) Patent Application Publication
(10) Pub. No.: US 2026/0015253 A1
(43) Pub. Date: Jan. 15, 2026

(54) METAL COMPOSITE COMPOUND AND METHOD FOR PRODUCING POSITIVE ELECTRODE ACTIVE MATERIAL FOR LITHIUM SECONDARY BATTERY

(71) Applicant: TANAKA CHEMICAL CORPORATION, Fukui-shi, Fukui (JP)

(72) Inventor: Ryota KOBAYASHI, Fukui-shi (JP)

(21) Appl. No.: 18/994,322

(22) PCT Filed: Jul. 14, 2023
(86) PCT No.: PCT/JP2023/026145

§ 371 Date: Jan. 14, 2025

(30) Foreign Application Priority Data
Jul. 15, 2022 (JP) 2022-114312

(51) Int. Cl. C01G 53/506; H01M 10/0525

(52) U.S. Cl. CPC C01G 53/506; H01M 10/0525; C01P 2004/54; C01P 2004/61; C01P 2006/40

(57) ABSTRACT

The present invention pertains to a metal composite compound that contains a transition metal element and is used as a precursor of a positive electrode active material for a lithium ion secondary battery, the metal composite compound being in a form of particles, wherein when a 50% cumulative volume particle diameter (D₅₀) and a 90% cumulative volume particle diameter (D₉₀) of the particles measured by a laser diffraction scattering method are denoted as a (μm) and b (μm), respectively, a ratio of B (MPa), which is an average particle strength of particles having a particle diameter of b±1.0 (μm), with respect to A (MPa), which is an average particle strength of particles having a particle diameter of a±1.0 (μm), i.e., B/A, is 0.85 or more and 1 or less.

### TECHNICAL FIELD

The present invention relates to a metal composite compound and a method for producing a positive electrode active material for a lithium secondary battery.

Priority is claimed on Japanese Patent Application No. 2022-114312, filed Jul. 15, 2022, the content of which is incorporated herein by reference.

### BACKGROUND ART

As a method for producing a positive electrode active material for a lithium secondary battery, for example, there is a method of mixing a lithium compound and a metal composite compound containing a metal element other than Li, followed by calcination.

Regarding a method for producing a positive electrode active material for a lithium secondary battery, for example, Patent Document 1 discloses a method for producing a positive electrode active material for a non-aqueous electrolyte secondary battery, which includes: a step of weighing out and mixing a metal composite hydroxide and lithium hydroxide to obtain a mixture; and a step of performing first stage calcination by heating the mixture obtained in the above step from room temperature to 450 to 550° C. at a rate of temperature increase of 0.5 to 15° C./min and holding the mixture at the attained temperature for 1 to 10 hours, and then further performing second stage calcination by heating the mixture to 650 to 800° C. at a rate of temperature increase of 1 to 5° C./min and holding the mixture at the attained temperature for 0.6 to 30 hours, followed by furnace cooling to obtain a positive electrode active material for a non-aqueous electrolyte secondary battery.

### CITATION LIST

### Patent Document

Patent Document 1: Japanese Unexamined Patent Application, First Publication No. 2007-257985

### SUMMARY OF INVENTION

### Technical Problem

The calcination temperature in the step of calcining a mixture of a lithium compound and a metal composite compound containing a metal element other than Li is determined by the reactivity of the lithium compound with the metal composite compound. When the reactivity of the metal composite compound with respect to the lithium compound is low, a high calcination temperature is required.

On the other hand, if the calcination temperature is too high, the crystal structure of a positive electrode active material for lithium secondary batteries, which is the obtained lithium metal composite oxide, is easily destroyed, and the performance of the resulting lithium secondary battery is easily reduced. In addition, a lot of energy is required for calcination, which is not efficient.

The present invention has been made in view of the above circumstances, and aims to provide: a metal composite compound that is highly reactive with a lithium compound and is used as a precursor of a positive electrode active material for a lithium ion secondary battery; and a method for producing a positive electrode active material for a lithium secondary battery using the aforementioned metal composite compound.

### Solution to Problem

The present invention includes the following [1] to [7].

[1] A metal composite compound that contains a transition metal element and is used as a precursor of a positive electrode active material for a lithium ion secondary battery, the aforementioned metal composite compound being in a form of particles, wherein when a 50% cumulative volume particle diameter (D₅₀) and a 90% cumulative volume particle diameter (D₉₀) of the aforementioned particles measured by a laser diffraction scattering method are denoted as a (μm) and b (μm), respectively, a ratio of B (MPa), which is an average particle strength of particles having a particle diameter of b±1.0 (μm), with respect to A (MPa), which is an average particle strength of particles having a particle diameter of a±1.0 (μm), i.e., B/A, is 0.85 or more and 1 or less.

[2] The metal composite compound according to [1], wherein the aforementioned D₅₀ is 5.0 μm or more and 15.0 μm or less.

[3] The metal composite compound according to [1] or [2], wherein the aforementioned D₉₀ is 7.5 μm or more and 30.0 μm or less.

[4] The metal composite compound according to any one of [1] to [3], wherein a ratio of the aforementioned D₉₀ with respect to the aforementioned D₅₀ (D₉₀/D₅₀) is 1.3 or more and 2.0 or less.

[5] The metal composite compound according to any one of [1] to [4], which is represented by the following composition formula (I):

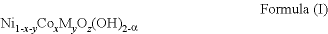

(in the aforementioned composition formula (I), 0≤x≤0.45, 0≤y≤0.45, 0<x+y≤0.9, 0≤z≤3, −0.5≤α≤2, and α−z<2 are satisfied, and M is one or more elements selected from the group consisting of Zr, Al, Ti, Mn, B, Mg, Nb, Mo, and W.)

[6] The metal composite compound according to [5], which satisfies x+y≤0.3 in the aforementioned composition formula (I).

[7] A method for producing a positive electrode active material for a lithium secondary battery, the method including a mixing step for mixing the metal composite compound of any one of [1] to [6] with a lithium compound, and a calcination step for calcining the obtained mixture at a temperature of 500° C. to 1,000° C. in an oxygen-containing atmosphere.

### Advantageous Effects of Invention

According to the present invention, it is possible to provide: a metal composite compound that is highly reactive with a lithium compound and is used as a precursor of a positive electrode active material for a lithium ion secondary battery; and a method for producing a positive electrode active material for a lithium secondary battery using the aforementioned metal composite compound.

### BRIEF DESCRIPTION OF DRAWINGS

FIG. 1 A diagram showing the results of TG measurements of mixtures of metal composite compounds and lithium compounds in Example 1 and Comparative Example 1.

### DESCRIPTION OF EMBODIMENTS

The definitions of terms used in the present specification are as follows.

A metal composite compound is hereinafter also referred to as an “MCC.”

A lithium metal composite oxide (LiMO) is hereinafter also referred to as “LiMO”.

A positive electrode (cathode) active material for a lithium secondary battery is hereinafter also referred to as a “CAM.”

“Ni” indicates elemental Ni, not a simple substance of nickel metal. The same applies to the notations of other elements such as Co and Mn.

The term “primary particle” refers to a particle that does not have a grain boundary in appearance when observed at a visual field magnification of 20,000 times using a scanning electron microscope or the like.

The term “secondary particle” refers to a particle formed by aggregation of the primary particles. In other words, secondary particles are aggregates of primary particles.

A “metal element” also includes B which is a metalloid element.

Regarding numerical ranges, “A or more and B or less” is expressed as “A to B”.

For example, when a numerical range is described as “1 to 10 MPa,” it means a range from 1 MPa to 10 MPa, and refers to a numerical range including 1 MPa as the lower limit value and 10 MPa as the upper limit value.

The measurement methods for each parameter of MCC in the present specification are as follows.

### Cumulative Volume Particle Diameter

The cumulative volume particle diameter (unit: μm) of MCC particles can be obtained from the particle size distribution of MCC particles measured by a laser diffraction scattering method. More specifically, 0.1 g of an MCC powder is added into 50 mL of a 0.2% by mass aqueous solution of sodium hexametaphosphate to obtain a dispersion liquid in which the powder is dispersed. Next, the particle size distribution of the obtained dispersion liquid is measured using a laser diffraction scattering particle size distribution measuring device (for example, Microtrac MT3300EXII manufactured by MicrotracBEL Corporation) to obtain a volume-based cumulative particle size distribution curve. In the obtained cumulative particle size distribution curve, from the fine particle side, the particle diameter value at 50 cumulative percent is 50% cumulative volume particle diameter (hereinafter also referred to as “D₅₀”), and the particle diameter value at 90 cumulative percent is 90% cumulative volume particle diameter (hereinafter also referred to as “D₉₀”).

### Average Particle Strength

The average particle strength (unit: MPa) of MCC particles can be measured and calculated as follows. First, an arbitrary number of particles are randomly selected from the MCC particles. Using a microcompression tester (for example, MCT-510 manufactured by Shimadzu Corporation), the particle diameter and particle strength of each of the selected particles are measured. Here, the particle strength Cs (unit: MPa) can be determined by the following formula (A). In the following formula (A), P denotes the test force (unit: N) and d denotes the particle diameter (unit: mm). Pis a pressure value at which the displacement becomes maximum while the test pressure remains almost constant when the test pressure is gradually increased. d is a value obtained by measuring the diameters in the X and Y directions in an image observed by the microcompression tester and calculating the average value thereof.

$$Cs = 2.8 P / π {d}^{2} \qquad ( A )$$

The average value of Cs obtained for an arbitrary number of particles is the average particle strength.

When the 50% cumulative volume particle diameter of MCC particles described below (D₅₀) is denoted as a (μm), in measuring and calculating the average particle strength A (MPa) of particles with a particle diameter of a±1.0 (μm), five particles with a particle diameter of a±1.0 (μm) are randomly selected.

When the 90% cumulative volume particle diameter of MCC particles (D₉₀) is denoted as b (μm), in measuring and calculating the average particle strength B (MPa) of particles with a particle diameter of b±1.0 (μm), five particles with a particle diameter of b±1.0 (μm) are randomly selected.

It should be noted that the particles to be measured may be either secondary or primary particles, but are usually secondary particles, as long as the above particle diameter is satisfied.

Since particle strength is normalized by particle diameter, if the structure of each particle is the same, the particle strength will be the same (average particle strength±5%) even among particles having different particle diameters. On the other hand, if the particle strength differs among particles, it can be said that the structure of each particle is different.

### Standard Deviation of Particle Strength

The standard deviation of the particle strength of MCC can be calculated from the average particle strength of the 20 particles and the Cs of the 20 particles obtained as described above in the section entitled (average particle strength). It should be noted that when calculating the standard deviation of particle strength, the 20 particles are 20 particles randomly selected without considering the above-mentioned requirements a±1.0 (μm) and b±1.0 (μm).

### Composition

The composition of each metal element in MCC can be measured by inductively coupled plasma emission spectrometry (ICP). For example, after dissolving MCC in hydrochloric acid, the amount of each metal element can be measured using an inductively coupled plasma optical emission spectrometer (for example, SPS3000 manufactured by SII Nano Technology Inc.).

### BET Specific Surface Area

The BET specific surface area (unit: m²/g) of MCC can be measured by the BET (Brunauer, Emmett, Teller) method. Nitrogen gas is used as an adsorption gas in measuring the BET specific surface area. For example, after drying 1 g of a powder to be measured in a nitrogen atmosphere at 105° C. for 30 minutes, measurement can be conducted using a BET specific surface area meter (for example, Macsorb (registered trademark) manufactured by Mountech Co., Ltd.).

The evaluation method for MCC in the present specification is as follows.

### Evaluation of Reactivity of MCC with Lithium Compounds

The reactivity of MCC with lithium compounds can be evaluated by thermogravimetry (TG). For example, after mixing MCC with lithium hydroxide, the peak positions in DTG curves showing the rate of change of TG are compared using a TG measurement device (for example, TG/DTA6300 manufactured by Hitachi, Ltd.), and if the peak is present on the lower temperature side, it can be determined that the reactivity with lithium is higher. For the measurement, for example, lithium hydroxide is mixed with MCC so that the molar ratio of lithium/(metal in MCC) is 1.05 to prepare a mixture. TG measurement is conducted on the obtained mixture at a maximum temperature of 500° C., a rate of temperature increase of 10° C./min, a sampling frequency of 1 time/sec, and an oxygen supply rate of 200 mL/min.

### Metal Composite Compound

The MCC of the present embodiment can be used as a precursor of CAM. The MCC contains a transition metal element. The MCC is in the form of particles.

When the 50% cumulative volume particle diameter (D₅₀) and the 90% cumulative volume particle diameter (D₉₀) of the aforementioned particles measured by a laser diffraction type particle size distribution meter are denoted as a (μm) and b (μm), respectively, a ratio of B (MPa), which is an average particle strength of particles having a particle diameter of b±1.0 (μm), with respect to A (MPa), which is an average particle strength of particles having a particle diameter of a±1.0 (μm), i.e., B/A, is 0.85 or more and 1 or less.

The MCC is an aggregate of a plurality of particles. In other words, the MCC is in a powder form. The MCC may contain only secondary particles, or may be a mixture of primary particles and secondary particles.

The B/A ratio of MCC is 0.85 or more and 1 or less, preferably from 0.90 to 1, more preferably from 0.93 to 1, and still more preferably from 0.95 to 1. When the B/A ratio is equal to or more than the lower limit value of the above range, the reactivity of MCC with lithium compounds is increased.

As described above in the section entitled (average particle strength), since the particle strength in the present specification is normalized by the particle diameter, if the structure of each particle is the same, the particle strength will be the same (average particle strength ±5%) even among particles having different particle diameters. On the other hand, particles with a relatively large particle diameter take longer to form than particles with a relatively small particle diameter, and tend to have low crystallinity. Therefore, the particle strength tends to decrease as the particle diameter increases.

On the other hand, in the MCC of the present embodiment, the B/A ratio is 0.85 or more, and the particle strength of the particles is relatively uniform regardless of the particle diameter. The inventors of the present application have found that such an MCC with a relatively uniform particle strength regardless of the particle diameter has high reactivity with lithium compounds.

If the MCC has a high reactivity with lithium compounds, it becomes possible to calcine a mixture of MCC and lithium compounds at a low temperature in the production of CAM, which is LiMO, thereby suppressing the destruction of the crystal structure of LiMO caused by calcining at high temperatures, and suppressing the deterioration of the performance of the resulting lithium secondary battery. In addition, CAM can be produced efficiently without requiring a large amount of energy for calcination.

As described above in the section entitled (average particle strength), since the particle strength of particles is normalized by the particle diameter, the theoretical upper limit value of the B/A ratio is 1. However, due to measurement errors of the average particle strength, and the like, the B/A ratio may exceed 1. The range of 0.85 or more and 1 or less for the B/A ratio in the present specification also includes values where the B/A ratio is more than 1 and is 1 when rounded off to the nearest whole number. In other words, values where the B/A ratio is more than 1 and is 1 when rounded off to the nearest whole number is considered to be 1.

For example, the B/A ratio is preferably from 0.85 to 1.10, more preferably from 0.90 to 1.05, still more preferably from 0.93 to 1.03, and particularly preferably from 0.95 to 1.00.

A and B of the MCC particles are preferably each independently 20 MPa or more, more preferably 30 MPa or more, and still more preferably 40 MPa or more. A and B are preferably 100 MPa or less, more preferably 80 MPa or less, still more preferably 70 MPa or less, and particularly preferably 60 MPa or less.

The above lower limit values and upper limit values can be arbitrarily combined.

For example, A and B are preferably each independently from 20 to 100 MPa, more preferably from 20 to 80 MPa, still more preferably from 30 to 70 MPa, and particularly preferably from 40 to 60 MPa. When A and B of MCC particles are equal to or more than the above lower limit value, particle cracking during the rolling process of electrode production can be suppressed. When A and B of MCC particles are equal to or less than the above upper limit value, the risk of contamination from equipment during CAM manufacturing processes, and the like can be reduced.

The standard deviation of particle strength is preferably 15 MPa or less, more preferably 10 MPa or less, and still more preferably 8 MPa or less. The standard deviation of particle strength is preferably 2 MPa or more, more preferably 4 MPa or more, and still more preferably 6 MPa or more.

The above lower limit values and upper limit values can be arbitrarily combined.

For example, the standard deviation of particle strength is preferably from 2 to 15 MPa, more preferably from 4 to 10 MPa, and still more preferably from 6 to 8 MPa.

The average particle strength is preferably 20 MPa or more, more preferably 30 MPa or more, and still more preferably 40 MPa or more. The average particle strength is preferably 100 MPa or less, more preferably 80 MPa or less, and still more preferably 60 MPa or less.

The above lower limit values and upper limit values can be arbitrarily combined.

For example, the average particle strength is preferably from 20 to 100 MPa, more preferably from 30 to 80 MPa, and still more preferably from 40 to 60 MPa.

The D₅₀ of the MCC particles is preferably 5.0 μm or more and 15.0 μm or less. The D₅₀ is preferably 5.0 μm or more, more preferably 7.0 μm or more, and still more preferably 9.0 μm or more. The D₅₀ is preferably 15.0 μm or less, more preferably 14.0 μm or less, still more preferably 13.0 μm or less, and particularly preferably 12.0 μm or less.

The above lower limit values and upper limit values can be arbitrarily combined.

For example, the D₅₀ is more preferably from 7.0 to 14.0 μm, still more preferably from 9.0 to 13.0 μm, and particularly preferably from 9.0 to 12.0 μm. When the D₅₀ is equal to or more than the above lower limit value, it is possible to suppress a decrease in productivity due to a decrease in filling properties. When the Dso is equal to or less than the above upper limit value, it is possible to suppress particle cracking due to a decrease in particle strength.

The D₉₀ of the MCC particles is preferably 7.5 μm or more and 30.0 μm or less. The D₉₀ is preferably 7.0 μm or more, more preferably 7.5 μm or more, still more preferably 12.0 μm or more, even more preferably 15.0 μm or more, and particularly preferably 18.0 μm or more. The D₉₀ is preferably 30.0 μm or less, more preferably 25.0 μm or less, and still more preferably 20.0 μm or less.

The above lower limit values and upper limit values can be arbitrarily combined.

For example, the D₉₀ is preferably from 7.0 to 30.0 μm, more preferably from 7.5 to 30.0 μm, still more preferably from 12.0 to 25.0 μm, even more preferably from 15.0 to 20.0 μm, and particularly preferably from 18.0 to 20.0 μm. When the D₉₀ is equal to or more than the above lower limit value, it is possible to suppress a decrease in productivity due to a decrease in filling properties. When the D₉₀ is equal to or less than the above upper limit value, it is possible to suppress particle cracking due to a decrease in particle strength.

The ratio of D₉₀ with respect to D₅₀ (D₉₀/D₅₀) of the MCC particles is preferably 1.3 or more and 2.0 or less. The D₉₀/D₅₀ ratio is preferably 1.3 or more, more preferably 1.4 or more, and still more preferably 1.5 or more. The D₉₀/D₅₀ ratio is preferably 2.0 or less, more preferably 1.9 or less, and still more preferably 1.8 or less.

The above lower limit values and upper limit values can be arbitrarily combined.

For example, the D₉₀/D₅₀ ratio is more preferably from 1.4 to 1.9, and still more preferably from 1.5 to 1.8. When the D₉₀/D₅₀ ratio is equal to or less than the above upper limit value, the difference in particle strength due to particle diameter can be reduced.

The BET specific surface area of MCC is preferably 2.0 m²/g or more, more preferably 3.0 m²/g or more, still more preferably 4.0 m²/g or more, and particularly preferably 5.0 m²/g or more. The BET specific surface area is preferably 15.0 m²/g or less, more preferably 12.0 m²/g or less, still more preferably 10.0 m²/g or less, and particularly preferably 9.0 m²/g or less.

The above lower limit values and upper limit values can be arbitrarily combined.

For example, the BET specific surface area is preferably from 2.0 to 15.0 m²/g, more preferably from 3.0 to 12.0 m²/g, still more preferably from 4.0 to 10.0 m²/g, and particularly preferably from 5.0 to 9.0 m²/g. When the BET specific surface area is equal to or more than the above lower limit value, it is possible to suppress a decrease in reactivity with lithium compounds. When the BET specific surface area is equal to or less than the above upper limit value, it is possible to suppress sintering due to an excessive reaction with lithium compounds.

In the present embodiment, from the viewpoint of facilitating the reaction during the production of LiMO, the crystal structure of MCC preferably has a layered structure and belongs to any one of hexagonal, orthorhombic, and monoclinic crystal systems, and particularly preferably belongs to hexagonal crystal systems.

### Composition

The MCC contains a transition metal element. As the transition metal element, the MCC preferably contains at least one transition metal element selected from the group consisting of Ni, Co, and Mn, and more preferably contains Ni and Co. The MCC does not substantially contain Li. The above expression “does not substantially contain Li” means that the ratio of the number of moles of Li with respect to the total number of moles of transition metal elements contained in the MCC is 0.1 or less.

### Composition Formula

The MCC is preferably a compound represented by the following composition formula (I).

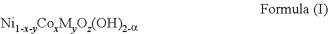

In the above composition formula (I), 0≤x≤0.45, 0≤y≤0.45, 0<x+y≤0.9, 0≤z≤3, −0.5≤α≤2, and α−z<2 are satisfied, and M is one or more elements selected from the group consisting of Zr, Al, Ti, Mn, B, Mg, Nb, Mo, and W.

The MCC is preferably a hydroxide represented by the following composition formula (I)-1.

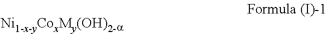

In the above composition formula (I)-1, 0≤x≤0.45, 0≤y≤0.45, 0<x+y≤0.9, −0.5≤α≤2 are satisfied, and M is one or more elements selected from the group consisting of Zr, Al, Ti, Mn, B, Mg, Nb, Mo, and W.

When y is more than 0, Mis preferably one or more elements selected from the group consisting of Mn, Zr, and Al, and is more preferably Mn.

x is preferably 0.01 or more, more preferably 0.02 or more, and particularly preferably 0.03 or more.

x is preferably 0.44 or less, more preferably 0.42 or less, still more preferably 0.40 or less, and particularly preferably 0.20 or less.

The above upper limit values and lower limit values of x can be arbitrarily combined.

The above composition formula (I) or the above composition formula (I)-1 preferably satisfies 0.01≤x≤0.44, more preferably satisfies 0.02≤x≤0.42, still more preferably satisfies 0.03≤x≤0.40, and particularly preferably satisfies 0.03≤x≤0.20.

y is preferably 0.01 or more, more preferably 0.02 or more, and particularly preferably 0.03 or more.

y is preferably 0.44 or less, more preferably 0.42 or less, still more preferably 0.40 or less, and particularly preferably 0.09 or less.

The above upper limit values and lower limit values of y can be arbitrarily combined.

The above composition formula (I) or the above composition formula (I)-1 preferably satisfies 0.01≤y≤0.44, more preferably satisfies 0.02≤y≤0.42, still more preferably satisfies 0.03≤y≤0.40, and particularly preferably satisfies 0.03≤y≤0.09.

x+y is preferably 0.01 or more, more preferably 0.03 or more, and particularly preferably 0.05 or more.

Further, x+y is preferably 0.3 or less, more preferably 0.25 or less, still more preferably 0.2 or less, and particularly preferably 0.18 or less.

The above upper limit values and lower limit values of x+y can be arbitrarily combined.

The above composition formula (I) or the above composition formula (I)-1 preferably satisfies 0.01≤x+y≤0.3, more preferably satisfies 0.03≤x+y≤0.25, still more preferably satisfies 0.05≤x+y≤0.2, and particularly preferably satisfies 0.05≤x+y≤0.18.

z is preferably 0.02 or more, more preferably 0.03 or more, and particularly preferably 0.05 or more.

z is preferably 2.8 or less, more preferably 2.6 or less, and particularly preferably 2.4 or less.

The above upper limit values and lower limit values can be arbitrarily combined.

The above composition formula (I) preferably satisfies 0≤z≤2.8, more preferably satisfies 0.02≤z≤2.8, still more preferably satisfies 0.03≤z≤2.6, and particularly preferably satisfies 0.05≤z≤2.4.

α is preferably −0.45 or more, more preferably −0.40 or more, and particularly preferably −0.35 or more.

α is preferably 1.8 or less, more preferably 1.6 or less, and particularly preferably 1.4 or less. The above upper limit values and lower limit values can be arbitrarily combined.

The above composition formula (I) or the above composition formula (I)-1 preferably satisfies −0.45≤α≤1.8, more preferably satisfies −0.40≤α≤1.6, and particularly preferably satisfies −0.35≤α≤1.4.

In the present embodiment, it is preferable that the above composition formula (I) or the above composition formula (I)-1 satisfies 0≤x≤0.29, 0.01≤y≤0.3, 0.01≤x+y≤0.3, and −0.45≤α≤1.8, and the above composition formula (I) satisfies 0≤z≤2.8.

### Method for Producing Metal Composite Compound

The method for producing MCC in the present embodiment includes reacting a solution of a transition metal salt with a complexing agent and an alkaline solution. In this case, the obtained MCC is a metal composite hydroxide. The metal composite hydroxide can be produced by a known batch-type coprecipitation method or continuous-type coprecipitation method. When producing a metal composite oxide as the MCC, the above metal composite hydroxide may be oxidized.

Hereinafter, a method for producing an MCC containing Ni, Co, and Mn will be described as an example. More specifically, a nickel salt solution, a cobalt salt solution, a manganese salt solution, a complexing agent, and an alkaline solution are reacted by the continuous-type coprecipitation method described in Japanese Unexamined Patent Application, First Publication No. 2002-201028 to produce a metal composite hydroxide represented by Ni_{(1-x′-y′)}Co_{x′}Mn_{y′}(OH)₂. For example, when producing an MCC represented by the above composition formula (I) and the above composition formula (I)-1, x′ and y′ correspond to x and y in the above composition formula (I) and the above composition formula (I)-1, respectively.

Although there is no particular limitation with aspect to a nickel salt as a solute in the nickel salt solution, for example, at least one of nickel sulfate, nickel nitrate, nickel chloride and nickel acetate can be used.

As a cobalt salt serving as a solute of the cobalt salt solution, for example, at least one of cobalt sulfate, cobalt nitrate, cobalt chloride, and cobalt acetate can be used.

As a manganese salt serving as a solute of the manganese salt solution, for example, at least one of manganese sulfate, manganese nitrate, manganese chloride, and manganese acetate can be used.

It should be noted that even when producing an MCC containing a metal other than Ni, Co, and Mn, a sulfate, nitrate, chloride, or acetate of this metal can be used as the solute.

The metal salt is used in a ratio corresponding to the composition ratio of the above Ni_{(1-x′-y′)}Co_{x′}Mn_{y′}(OH)₂. That is, the amount of each metal salt is specified so that the molar ratio of Ni, Co, and Mn in a mixed solution containing the above metal salts corresponds to (1−x′−y′):x′:y′ in the above composition formula. Further, water is used as a solvent.

The method for supplying the metal salt solution (hereinafter also referred to as a “raw material solution”) to a reaction tank is not particularly limited as long as the effects of the present invention are exhibited, but it is preferable to supply the raw material solution by adding it dropwise into the reaction tank.

In the present embodiment, it is preferable to control the amount of metal contained per number of droplets (hereinafter also referred to as “Me/drop”) of the raw material solution supplied to the reaction tank.

Me/drop is expressed by the following formula (II).

$$Me / drop = ( ( Me concentration ) \times ( Me supply rate ) ) / ( ( number of droplets ) \times ( reaction solution volume ) ) \qquad Formula ( II )$$

In the above formula (II), the “Me concentration” is the transition metal concentration of the raw material solution (mol/L), the “Me supply rate” is the supply rate of the raw material solution (L/min), the “number of droplets” is the number of droplets (drops) of the raw material solution added dropwise simultaneously, and the “reaction solution volume” is the volume (m³) of the reaction solution in the reaction tank. It should be noted that the unit of Me/drop is [mol/min/drop/m³]. Hereinafter, when the numerical value of Me/drop is shown, the unit is omitted.

Me/drop is preferably from 0.10 to 0.34, more preferably from 0.15 to 0.32, and still more preferably from 0.18 to 0.30. When Me/drop is equal to or more than the lower limit value of the above range, it is easy to ensure productivity. When Me/drop is equal to or less than the upper limit value of the above range, particle growth proceeds mildly and crystallinity is likely to increase. As a result, even for particles with a relatively large particle diameter, the particle strength is likely to be large and the B/A ratio is likely to be 0.85 or more and 1 or less.

The number of droplets is preferably from 2 to 20 drops, more preferably from 3 to 15 drops, and still more preferably from 4 to 10 drops. The amount of dropwise addition in each droplet is substantially the same. The expression “amount of dropwise addition being substantially the same” means that the amount of dropwise addition in each droplet is from 80 to 120% of the average value of the amount of dropwise addition per droplet, which is obtained from the amounts of dropwise addition for all droplets.

The complexing agent is capable of forming a complex with nickel ions, cobalt ions, and manganese ions in an aqueous solution, examples thereof include ammonium ion donors such as ammonium hydroxide, ammonium sulfate, ammonium chloride, ammonium carbonate, and ammonium fluoride, hydrazine, ethylenediaminetetraacetic acid, nitrilotriacetic acid, uracildiacetic acid, and glycine, and ammonium ion donors are preferred.

The amount of the complexing agent contained in a mixed solution containing the nickel salt solution, cobalt salt solution, manganese salt solution, and complexing agent is preferably such that, for example, the molar ratio with respect to the total number of moles of the metal salts (nickel salt, cobalt salt, and manganese salt) is more than 0 and equal to or less than 2.0.

When an ammonium ion donor is used as the complexing agent, the ammonia concentration with respect to the total volume of the solution in the reaction tank is preferably from 0.5 to 10 g/L, more preferably from 1 to 8 g/L, and still more preferably from 1.5 to 6 g/L. When the ammonia concentration is equal to or higher than the lower limit value of the above range, the complexing agent is likely to cause particle growth of MCC, and D₅₀ and D₉₀ are likely to be equal to or higher than the lower limit value of the above range. When the ammonia concentration is equal to or lower than the upper limit value of the above range, excessive particle growth of MCC is suppressed, and D₅₀ and D₉₀ are likely to be equal to or lower than the upper limit value of the above range.

In the coprecipitation method, in order to adjust the pH value of the mixed solution containing the nickel salt solution, cobalt salt solution, manganese salt solution, and complexing agent, an alkaline solution is added to the mixed solution before the pH of the mixed solution changes from alkaline to neutral. Examples of the alkaline solution include an aqueous solution of an alkali metal hydroxide. Further, examples of the alkali metal hydroxide include sodium hydroxide and potassium hydroxide.

It should be noted that the pH value in the present specification is defined as a value measured when the temperature of the mixed solution is 40° C. The pH of the mixed solution is measured when the temperature of the mixed solution sampled from the reaction tank reaches 40° C. When the sampled mixed solution is below 40° C., the mixed solution is heated to 40° C. and the pH is measured. When the sampled mixed solution is above 40° C., the mixed solution is cooled to 40° C. and the pH is measured.

When the above nickel salt solution, cobalt salt solution, and manganese salt solution, as well as a complexing agent, are continuously supplied to the reaction tank, Ni, Co, and Mn react to produce Ni_{(1-x′-y′)}Co_{x′}Mn_{y′}(OH)².

The reaction temperature is preferably from 30 to 80° C., and more preferably from 40 to 75° C.

The pH value in the reaction tank is preferably from 10.0 to 12.0, and more preferably from 10.5 to 11.5. When the pH is equal to or higher than the lower limit value of the above range, the neutralization reaction proceeds sufficiently, and D₅₀ and D₉₀ are likely to be equal to or more than the lower limit value of the above range. When the pH is equal to or lower than the upper limit value of the above range, since the number of MCC particles in the reaction tank will not be too large, the growth of each particle will be promoted, and D₅₀ and D₉₀ are likely to be equal to or more than the lower limit value of the above range.

The reaction precipitate formed in the reaction tank is neutralized while being stirred. The time for neutralizing the reaction precipitate is, for example, from 1 to 20 hours.

As the reaction tank used in a continuous-type coprecipitation method, a type of reaction tank that overflows can be used in order to separate the formed reaction precipitate.

When producing a metal composite hydroxide by a batch-type coprecipitation method, examples of the reaction tank include a reaction tank without an overflow pipe, and a device equipped with a concentration tank connected to an overflow pipe and having a mechanism by which the overflowed reaction precipitate is concentrated in the concentration tank and circulated once again to the reaction tank.

The reaction tank preferably has a means for supplying the raw material solution by adding it dropwise into the reaction tank. In that case, it is preferable that the means is capable of realizing the above-mentioned preferred number of droplets. More specifically, the reaction tank preferably has a number of dropping ports corresponding to the number of droplets described above.

Various gases, for example, inert gases such as nitrogen, argon, or carbon dioxide, oxidizing gases such as air or oxygen, or a mixed gas thereof, may be supplied into the reaction tank, and it is preferable to supply an inert gas into the reaction tank.

The above-mentioned Me/drop, reaction temperature, and ammonia concentration greatly affect the physical properties, such as particle strength, of the obtained MCC. Therefore, it is preferable to adjust various conditions appropriately.

In the present embodiment, it is preferable to set Me/drop to 0.10 to 0.34, the reaction temperature to 30 to 80° C., and the ammonia concentration to 0.5 to 10 g/L, and it is more preferable to set Me/drop to 0.15 to 0.32, the reaction temperature to 40 to 75° C., and the ammonia concentration to 1 to 8 g/L.

After the above reaction, the neutralized reaction precipitate is washed with water and then isolated. For the isolation, for example, a method of dehydrating a slurry containing the reaction precipitate (that is, a coprecipitated slurry) by centrifugation, suction filtration or the like is used.

The isolated reaction precipitate is washed, dehydrated, dried, and sieved to obtain a metal composite hydroxide containing Ni, Co, and Mn.

The reaction precipitate is preferably washed with water, weak acid water, or an alkaline cleaning solution. In the present embodiment, washing with an alkaline cleaning solution is preferred, and washing with an aqueous sodium hydroxide solution or an aqueous potassium hydroxide solution is more preferred.

The temperature of the water, weak acid water or alkaline cleaning solution used is preferably 30° C. or higher. Further, washing is preferably performed two or more times.

It should be noted that after washing with a solution other than water, it is preferable to further wash with water so that compounds derived from the solution do not remain in the reaction precipitate.

The drying temperature is preferably from 60 to 300° C., and more preferably from 80 to 250° C. The drying time is preferably from 0.5 to 3.0 hours, and more preferably from 1.0 to 2.5 hours. The drying pressure may be normal pressure or reduced pressure.

When producing a metal composite oxide as an MCC, a metal composite hydroxide may be heated to produce the metal composite oxide. More specifically, the metal composite hydroxide is heated at 400 to 700° C. If necessary, a plurality of heating steps may be performed. In the present specification, the heating temperature means the set temperature of a heating device. In the case of including a plurality of heating steps, it means the temperature when heating is performed at the maximum holding temperature in each heating step.

The heating temperature is preferably from 400 to 700° C., and more preferably from 450 to 680° C. When the heating temperature is from 400 to 700° C., the metal composite hydroxide is sufficiently oxidized, and a metal composite oxide having a BET specific surface area within an appropriate range is obtained. When the heating temperature is equal to or higher than the lower limit value of the above range, the metal composite hydroxide is sufficiently oxidized. When the heating temperature is equal to or lower than the upper limit value of the above range, excessive oxidation of the metal composite hydroxide is suppressed, and a decrease in the BET specific surface area of the metal composite oxide is suppressed.

The time for holding the above heating temperature may be from 0.1 to 20 hours, and is preferably from 0.5 to 10 hours. The rate of temperature increase to the above heating temperature is, for example, from 50 to 400° C./hour. Further, as the heating atmosphere, air, oxygen, nitrogen, argon, or a mixed gas thereof can be used.

The inside of the heating device may be under an appropriate oxygen-containing atmosphere. The oxygen-containing atmosphere may be a mixed gas atmosphere of an inert gas and an oxidizing gas, or may be a state in which an oxidizing agent is present under an inert gas atmosphere. By having an appropriate oxygen-containing atmosphere inside the heating device, a transition metal contained in the metal composite hydroxide is appropriately oxidized, making it easier to control the form of the metal composite oxide.

As the oxygen or oxidizing agent in the oxygen-containing atmosphere, a sufficient number of oxygen atoms need to be present in order to oxidize the transition metal.

When the oxygen-containing atmosphere is a mixed gas atmosphere of an inert gas and an oxidizing gas, the atmosphere in the heating device can be controlled by a method of allowing the oxidizing gas to pass through the heating device, bubbling the oxidizing gas into the mixed solution, or the like.

As the oxidizing agent, peroxides such as hydrogen peroxide, peroxide salts such as permanganates, perchlorates, hypochlorites, nitric acid, halogens, ozone, and the like can be used.

By heating the metal composite hydroxide obtained by the above-mentioned production method under the above-mentioned conditions, a metal composite oxide having a B/A ratio within the above-mentioned range can be obtained.

By the steps described above, an MCC can be produced.

### Method for Producing Positive Electrode Active Material for Lithium Secondary Battery

A method for producing a CAM includes a mixing step for mixing an MCC with a lithium compound, and a calcination step for calcining the obtained mixture at a temperature of 500° C. or higher and 1,000° C. or lower in an oxygen-containing atmosphere. A CAM, which is LiMO, can be produced by the above method.

The above-mentioned MCC of the present embodiment is used in the method for producing a CAM.

### Mixing Step

The MCC and a lithium compound are mixed

As the lithium compound used in the present embodiment, at least any one of lithium carbonate, lithium nitrate, lithium acetate, lithium hydroxide (including hydrates), lithium oxide, lithium chloride, and lithium fluoride can be used. Among these, either one of lithium hydroxide and lithium carbonate, or a mixture thereof, is preferred.

Further, when the raw material (reagent or the like) containing lithium hydroxide contains lithium carbonate, the content of lithium carbonate in the lithium hydroxide is preferably 5% by mass or less.

The lithium compound and the MCC are mixed in consideration of the composition ratio of the final target product, thereby obtaining a mixture of the lithium compound and the MCC. The amount (molar ratio) of lithium with respect to the total amount (taken as 1) of metals contained in the MCC is preferably from 0.98 to 1.20, more preferably from 1.04 to 1.10, and particularly preferably from 1.05 to 1.10.

### Calcination Step

The obtained mixture is calcined at a calcination temperature of 500° C. or higher and 1,000° C. or lower in an oxygen-containing atmosphere. By calcining the mixture, LiMO crystals grow.

The calcination temperature in the present specification refers to the temperature of the atmosphere in the calcination furnace, and means the maximum temperature of the holding temperature (maximum holding temperature).

When the calcination step includes a plurality of calcination stages, the calcination temperature means the temperature when heating is performed at the maximum holding temperature in each calcination stage.

The calcination temperature is, for example, preferably from 650 to 850° C., more preferably 680 to 830° C., and particularly preferably from 700 to 800° C. When the calcination temperature is equal to or higher than the lower limit value of the above range, a CAM having a strong crystal structure can be obtained. Further, when the calcination temperature is equal to or lower than the upper limit value of the above range, the volatilization of lithium on the particle surface of the CAM can be reduced. By using the MCC of the present embodiment, it is possible to perform the calcination at a lower temperature.

The retention time in the calcination is preferably from 3 to 50 hours, and more preferably from 4 to 20 hours. When the retention time in the calcination is equal to or less than the upper limit value of the above range, the volatilization of lithium is suppressed, and the deterioration in battery performance is suppressed. When the retention time in the calcination is equal to or more than the lower limit value of the above range, the development of crystals is promoted, and the deterioration in battery performance is suppressed.

The rate of temperature increase in the calcination step to reach the maximum holding temperature is preferably 80° C./hour or more, more preferably 100° C./hour or more, and particularly preferably 150° C./hour or more. The rate of temperature increase in the heating step to reach the maximum holding temperature is calculated from the time ranging from the start of temperature increase up to a point reaching the holding temperature in the calcination device.

The calcination step preferably includes a plurality of calcination stages with different calcination temperatures. For example, it is preferable to include a first calcination stage and a second calcination stage in which calcination is performed at a higher temperature than that in the first calcination stage. Calcination stages with different calcination temperatures and calcination times may be further included.

Depending on the desired composition, as the calcination atmosphere, air, oxygen, nitrogen, argon, a mixed gas thereof or the like is used, and a plurality of calcination steps is performed if necessary. The calcination atmosphere is preferably an oxygen-containing atmosphere.

The mixture of the MCC and the lithium compound may be calcined in the presence of an inert melting agent. The inert melting agent is added to such an extent that the initial capacity of the battery using the CAM is not impaired, and may remain in the calcination product. As the inert melting agent, for example, those described in WO 2019/177032A1 can be used.

The calcination device used at the time of calcination is not particularly limited, and may be, for example, a continuous calcination furnace or a fluidized calcination furnace. Examples of the continuous calcination furnace include a tunnel furnace and a roller hearth kiln. As a fluidized calcination furnace, a rotary kiln may be used.

A CAM can be obtained by calcining the mixture of the MCC and the lithium compound as described above.

### EXAMPLES

The present invention will be described in more detail below with reference to Examples, but the present invention is not limited thereto.

### Measurement of Various Parameters of MCC

Measurements of various parameters of MCC produced by the method described below were performed using the methods as described above in the sections entitled (cumulative volume particle diameter), (average particle strength), (standard deviation of particle strength), (composition), and (BET specific surface area).

### Evaluation of Reactivity of MCC with Lithium Compounds

The reactivity of MCC produced by the method described below with lithium compounds was evaluated by the method described above in the section entitled (evaluation of reactivity of MCC with lithium compounds). The evaluation criteria for reactivity are as follows.
A: The DTG peak position is 310° C. or lower.
B: The DTG peak position is higher than 310° C.

### Example 1

After pouring water into a reaction tank equipped with a stirrer and an overflow pipe, an aqueous sodium hydroxide solution was added thereto, and the liquid temperature was maintained at 70°° C. (reaction temperature).

An aqueous nickel sulfate solution, an aqueous cobalt sulfate solution, and an aqueous manganese sulfate solution were mixed so that the molar ratio of Ni:Co:Mn was 0.83:0.12:0.05 to prepare a mixed raw material solution 1.

The mixed raw material solution 1 and an aqueous ammonium sulfate solution as a complexing agent were continuously added into a reaction tank while stirring under a nitrogen flow. It should be noted that the mixed raw material solution 1 was added dropwise so that Me/drop=0.22. An aqueous sodium hydroxide solution was added dropwise at appropriate times so that the pH of the solution in the reaction tank became 11.1 (measurement temperature: 40° C.), and the rate of dropwise addition of the aqueous ammonium sulfate solution was adjusted so that the ammonium concentration in the tank became 2.1 g/L, thereby obtaining a reaction precipitate 1.

The reaction precipitate 1 was washed using a 0.5% by mass aqueous solution of sodium hydroxide. After washing, it was dehydrated using a centrifuge, washed with water, dehydrated, and dried to obtain a metal composite hydroxide 1 containing Ni, Co, and Mn. Various parameters of the metal composite hydroxide 1 are shown in Table 1 (hereinafter, the same applies to Examples 2 and 3, and Comparative Examples 1 and 2). It should be noted that 1−x−y, x, and y in the composition column in Table 1 correspond to those in the composition formula (I)-1 described above. Further, the average particle strength of 20 particles of the metal composite hydroxide 1 was 49.4 MPa, with a standard deviation of 7.8.

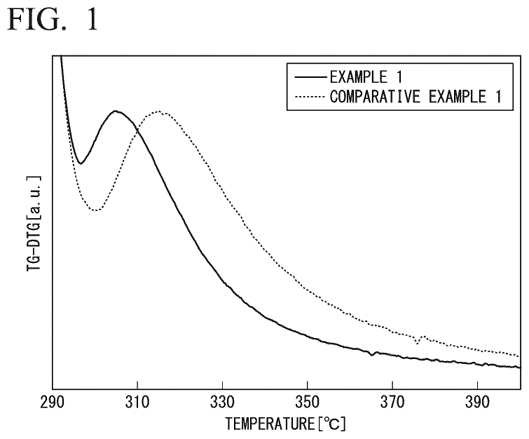

The reactivity with a lithium compound was evaluated using the obtained metal composite hydroxide 1. The results are shown in Table 1 (hereinafter, the same applies to Examples 2 and 3, and Comparative Examples 1 and 2). Further, the TG measurement results of Example 1 are shown in FIG. 1 (hereinafter, the same applies to Comparative Example 1). In Example 1 in FIG. 1, the upward peak near 305° C. is the reaction peak of the lithium compound and the metal composite hydroxide.

### Example 2

After pouring water into a reaction tank equipped with a stirrer and an overflow pipe, an aqueous sodium hydroxide solution was added thereto, and the liquid temperature was maintained at 70° C. (reaction temperature).

An aqueous nickel sulfate solution, an aqueous cobalt sulfate solution, and an aqueous manganese sulfate solution were mixed so that the molar ratio of Ni:Co:Mn was 0.83:0.12:0.05 to prepare a mixed raw material solution 2.

The mixed raw material solution 2 and an aqueous ammonium sulfate solution as a complexing agent were continuously added into a reaction tank while stirring under a nitrogen flow. It should be noted that the mixed raw material solution 2 was added dropwise so that Me/drop=0.28. An aqueous sodium hydroxide solution was added dropwise at appropriate times so that the pH of the solution in the reaction tank became 10.8 (measurement temperature: 40° C.), and the rate of dropwise addition of the aqueous ammonium sulfate solution was adjusted so that the ammonium concentration in the tank became 2.1 g/L, thereby obtaining a reaction precipitate 2.

The reaction precipitate 2 was washed using a 0.5% by mass aqueous solution of sodium hydroxide. After washing, it was dehydrated using a centrifuge, washed with water, dehydrated, and dried to obtain a metal composite hydroxide 2 containing Ni, Co, and Mn.

The reactivity with a lithium compound was evaluated using the obtained metal composite hydroxide 2.

### Example 3

After pouring water into a reaction tank equipped with a stirrer and an overflow pipe, an aqueous sodium hydroxide solution was added thereto, and the liquid temperature was maintained at 70° C. (reaction temperature).

An aqueous nickel sulfate solution, an aqueous cobalt sulfate solution, and an aqueous manganese sulfate solution were mixed so that the molar ratio of Ni:Co:Mn was 0.88:0.09:0.03 to prepare a mixed raw material solution 3.

The mixed raw material solution 3 and an aqueous ammonium sulfate solution as a complexing agent were continuously added into a reaction tank while stirring under a nitrogen flow. It should be noted that the mixed raw material solution 3 was added dropwise so that Me/drop=0.22. An aqueous sodium hydroxide solution was added dropwise at appropriate times so that the pH of the solution in the reaction tank became 11.2 (measurement temperature: 40° C.), and the rate of dropwise addition of the aqueous ammonium sulfate solution was adjusted so that the ammonium concentration in the tank became 2.1 g/L, thereby obtaining a reaction precipitate 3.

The reaction precipitate 3 was washed using a 0.5% by mass aqueous solution of sodium hydroxide. After washing, it was dehydrated using a centrifuge, washed with water, dehydrated, and dried to obtain a metal composite hydroxide 3 containing Ni, Co, and Mn.

The reactivity with a lithium compound was evaluated using the obtained metal composite hydroxide 3.

### Comparative Example 1

After pouring water into a reaction tank equipped with a stirrer and an overflow pipe, an aqueous sodium hydroxide solution was added thereto, and the liquid temperature was maintained at 71° C. (reaction temperature).

An aqueous nickel sulfate solution, an aqueous cobalt sulfate solution, and an aqueous manganese sulfate solution were mixed so that the molar ratio of Ni:Co:Mn was 0.83:0.12:0.05 to prepare a mixed raw material solution 4.

The mixed raw material solution 4 and an aqueous ammonium sulfate solution as a complexing agent were continuously added into a reaction tank while stirring under a nitrogen flow. It should be noted that the mixed raw material solution 4 was added dropwise so that Me/drop=1.31. An aqueous sodium hydroxide solution was added dropwise at appropriate times so that the pH of the solution in the reaction tank became 11.3 (measurement temperature: 40° C.), and the rate of dropwise addition of the aqueous ammonium sulfate solution was adjusted so that the ammonium concentration in the tank became 2.3 g/L, thereby obtaining a reaction precipitate 4.

The reaction precipitate 4 was washed using a 0.5% by mass aqueous solution of sodium hydroxide. After washing, it was dehydrated using a centrifuge, washed with water, dehydrated, and dried to obtain a metal composite hydroxide 4 containing Ni, Co, and Mn. The average particle strength of 20 particles of the metal composite hydroxide 4 was 48.9 MPa, with a standard deviation of 10.0.

The reactivity with a lithium compound was evaluated using the obtained metal composite hydroxide 4.

### Comparative Example 2

After pouring water into a reaction tank equipped with a stirrer and an overflow pipe, an aqueous sodium hydroxide solution was added thereto, and the liquid temperature was maintained at 71° C. (reaction temperature).

An aqueous nickel sulfate solution, an aqueous cobalt sulfate solution, and an aqueous manganese sulfate solution were mixed so that the molar ratio of Ni:Co:Mn was 0.88:0.09:0.03 to prepare a mixed raw material solution 5.

The mixed raw material solution 5 and an aqueous ammonium sulfate solution as a complexing agent were continuously added into a reaction tank while stirring under a nitrogen flow. It should be noted that the mixed raw material solution 5 was added dropwise so that Me/drop=1.13. An aqueous sodium hydroxide solution was added dropwise at appropriate times so that the pH of the solution in the reaction tank became 11.4 (measurement temperature: 40° C.), and the rate of dropwise addition of the aqueous ammonium sulfate solution was adjusted so that the ammonium concentration in the tank became 2.3 g/L, thereby obtaining a reaction precipitate 5.

The reaction precipitate 5 was washed using a 0.5% by mass aqueous solution of sodium hydroxide. After washing, it was dehydrated using a centrifuge, washed with water, dehydrated, and dried to obtain metal composite hydroxide 5 containing Ni, Co, and Mn.

The reactivity with a lithium compound was evaluated using the obtained metal composite hydroxide 5.

TABLE 1

| | Parameters of MCC | | | | | | | | | | | |
|---|---|---|---|---|---|---|---|---|---|---|---|---|
| | | | | | | | Average | | | | Specific | |
| | | | | | | | particle | Cumulative volume | | Cumulative | surface | |
| | Composition | | | | Average particle strength | | strength | particle diameter | | volume particle | area | Characteristic |
| | Ni | Co | M | Type | A | B | ratio | D₅₀ | D₉₀ | diameter ratio | BET | Reactivity |
| | 1 − x − y | x | y | of M | [MPa] | [MPa] | B/A | [μm] | [μm] | D₉₀/D₅₀ | [m²/g] | with Li |
| Ex. 1 | 0.83 | 0.12 | 0.05 | Mn | 47.1 | 44.7 | 0.95 | 11.1 | 18.4 | 1.66 | 7.5 | A |
| Ex. 2 | 0.83 | 0.12 | 0.05 | Mn | 43.2 | 39.2 | 0.91 | 11.3 | 18.9 | 1.67 | 7.2 | A |
| Ex. 3 | 0.88 | 0.09 | 0.03 | Mn | 53.6 | 53.4 | 1.00 | 11.9 | 18.3 | 1.54 | 8.8 | A |
| Comp. Ex. 1 | 0.83 | 0.12 | 0.05 | Mn | 51.2 | 41.5 | 0.81 | 11.0 | 18.3 | 1.66 | 9.6 | B |
| Comp. Ex. 2 | 0.88 | 0.09 | 0.03 | Mn | 58.8 | 42.7 | 0.73 | 11.4 | 21.4 | 1.88 | 16.2 | B |

The MCCs of Examples 1 to 3, in which the B/A ratio was 0.85 or more, were found to have higher reactivity with lithium compounds than the MCCs of Comparative Examples 1 and 2, in which the B/A ratio was less than 0.85.

1. A metal composite compound that comprises a transition metal element and is used as a precursor of a positive electrode active material for a lithium ion secondary battery, said metal composite compound being in a form of particles,
wherein when a 50% cumulative volume particle diameter (D₅₀) and 90% cumulative volume particle diameter (D₉₀) of said particles measured by a laser diffraction scattering method are denoted as a (μm) and b (μm), respectively, a ratio of B (MPa), which is an average particle strength of particles having a particle diameter of b±1.0 (μm), with respect to A (MPa), which is an average particle strength of particles having a particle diameter of a±1.0 (μm), i.e., B/A, is 0.85 or more and 1 or less.

2. The metal composite compound according to claim 1, wherein said D₅₀ is 5.0 μm or more and 15.0 μm or less.

3. The metal composite compound according to claim 1, wherein said D₉₀ is 7.5 μm or more and 30.0 μm or less.

4. The metal composite compound according to claim 1, wherein a ratio of said D₉₀ with respect to said D₅₀ (D₉₀/D₅₀) is 1.3 or more and 2.0 or less.

5. The metal composite compound according to claim 1, which is represented by the following composition formula (I):
Ni_{1-x-y}CoₓM_{y}O_{z}(OH)_{2-α} Formula (I)
(in said composition formula (I), 0≤x≤0.45, 0≤y≤0.45, 0<x+y≤0.9, 0≤z≤3, −0.5≤α≤2, and α−z<2 are satisfied, and M is one or more elements selected from the group consisting of Zr, Al, Ti, Mn, B, Mg, Nb, Mo, and W.)

6. The metal composite compound according to claim 5, which satisfies x+y≤0.3 in said composition formula (I).

7. A method for producing a positive electrode active material for a lithium secondary battery, the method comprising:
a mixing step for mixing the metal composite compound of claim 1 with a lithium compound; and
a calcination step for calcining the obtained mixture at a temperature of 500° C. to 1,000° C. in an oxygen-containing atmosphere.
